(19) United States
(12) Patent Application Publication
(10) Pub. No.: US 2015/0086443 A1
(43) Pub. Date: Mar. 26, 2015

(54) MICROFLUIDIC CHIPS WITH MICRO-TO-MACRO SEAL AND A METHOD OF MANUFACTURING MICROFLUIDIC CHIPS WITH MICRO-TO-MACRO SEAL

(71) Applicants: Tej PATEL, San Diego, CA (US); Ryan REVILLA, Downey, CA (US); MATTHEW D'OOGE, Carlsbad, CA (US)

(72) Inventors: Tej PATEL, San Diego, CA (US); Ryan REVILLA, Downey, CA (US); MATTHEW D'OOGE, Carlsbad, CA (US)

(73) Assignee: FLUXERGY, LLC, San Diego, CA (US)

(21) Appl. No.: 14/033,473

(22) Filed: Sep. 22, 2013

(51) Int. Cl. B01L 3/00; B05D 3/00; B05D 1/00

(52) U.S. Cl. CPC B01L 3/502707; B01L 3/502715; B05D 1/005; B05D 3/007; B01L 2300/04; B01L 2300/0887; B01L 2200/0689
USPC 422/502; 427/346

(57) ABSTRACT

A microfluidic chip for a microfluidic system includes a micro-to-macro seal. The microfluidic chip has a substrate, at least one microfluidic pathway in the substrate, and a PDMS seal layer on the substrate and above the microfluidic pathway. The PDMS seal layer provides a seal above the microfluidic pathway and prevent particles or contaminants entering the micro-channel during transportation or prior to application. During application, a needle or piping pierces through the PDMS seal layer, and fluid can be pumped into the microfluidic chip without concern for the fluid leaking despite high pressure required to pump or drive the fluid into the microfluidic pathway.

### BACKGROUND OF THE INVENTION

1. Field of the Invention

The present invention relates generally to a method of manufacturing microfluidic chips for handling fluid samples on a microfluidic level, and, more specifically, to microfluidic chips with micro-to-macro seal and a method of manufacturing microfluidic chips with micro-to-macro seal.

2. Discussion of the Related Art

Microfluidics can be used in medicine or cell biology researches and refers to the technology that relates to the flow of liquid in channels of micrometer size. At least one dimension of the channel is of the order of a micrometer or tens of micrometers to be considered as microfluidics. In particular, microfluidic devices are useful for manipulating or analyzing micro-sized fluid samples on microfluidic chips, with the fluid samples typically in extremely small volumes down to less than pico liters.

When manipulating or analyzing fluid samples, fluids are pumped onto the micro-channel of microfluidic chips. Presently, microfluidic chips have micro channels etched or molded in a PolyDiMethyiSiloxane (“PDMS”), silicon or glass chip. The micro-channel then is sealed when the chip is bonded to a glass slide.

FIGS. 1A-1D are perspective views of manufacturing a microfluidic chip mold according to the related art. The manufacturing of a microfluidic chip according to the related art takes a channel design and duplicates the channel design onto a photomask 10. As shown in FIG. 1A, a photoresist 22 is deposited onto a semiconductor wafer 20. As shown in FIG. 1B, the photomask 10 that reflects the channel design 12 is placed over the wafer 20, and the wafer 20 with the mask 10 undergoes UV exposition to cure the photoresist 22. FIG. 1C shows the wafer 20 with the cured photoresist 22′ being developed. The ‘negative’ image of a channel according to the channel design is etched away from the semiconductor wafer 20. As shown in FIG. 1D, after all residual photoresist are removed, the resulting wafer becomes a mold 20′ that provides the channel according to the channel design 12′.

FIG. 2 are perspective views of the steps of manufacturing a microfluidic chip according to the related art. As shown in FIG. 2, PDMS in liquid form 30 is poured onto the mold 20′. Liquid PDMS 30 may be mixed with crosslinking agent. The mold 20′ with liquid PDMS 30 is then placed into a furnace to harden PDMS 30. As PDMS is hardened, the hardened PDMS block 30′ duplicates the micro-channel 12″ according to the channel design. The PDMS block 30′ then may be separated from the mold 20′. To allow injection of fluid into the micro-channel 12″ (which will subsequently be sealed), inlet 14 or outlet 15 is then made in the PDMS block 30′ by drilling into the PDMS block 30′ using a needle. Then, the face of the PDMS block 30′ with micro-channels and a glass slide 32 are treated with plasma. Due to the plasma treatment, the PDMS block 30 and the treated glass slide 32′ can bond with one another and close the chip.

The resulting microfluidic chip according to the related art therefore has an open surface. The inlet and outlet openings are on the open surface of the microfluidic chip. Particles or contaminants may get into the micro-channel through the open surface and impact subsequent fluid sample analysis. Thus, there exists a need for preventing particles or contaminants entering into micro-channels of microfluidic chips.

### SUMMARY OF THE INVENTION

Accordingly, embodiments of the invention are directed to a method of manufacturing microfluidic chips for handling fluid samples on a microfluidic level and microfluidic chips that can substantially obviate one or more of the problems due to limitations and disadvantages of the related art.

An object of embodiments of the invention is to provide a method of manufacturing microfluidic chips with micro-to-macro seal, and microfluidic chips manufactured using the same.

An object of embodiments of the invention is to provide a method of manufacturing microfluidic chips with no open surface, and microfluidic chips manufactured using the same.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a microfluidic chip device according to an embodiment of the present invention includes a substrate having a thickness, at least one microfluidic pathway in the substrate, and a PDMS layer on the substrate and above the microfluidic pathway, wherein the PDMS layer provides a seal above the microfluidic pathway

In accordance with another embodiment of the invention, as embodied and broadly described, a microfluidic chip device includes a substrate having a thickness, at least one microfluidic pathway in the substrate, and a rubber layer on the substrate and above the microfluidic pathway, wherein the rubber layer provides a seal above the microfluidic pathway.

In accordance with another embodiment of the invention, as embodied and broadly described, a method for manufacturing a microfluidic chip device includes spinning a substrate having a first thickness and at least one microfluidic pathway in the substrate, depositing a layer of liquid PDMS onto the substrate, and hardening the PDMS layer.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated herein constituting a part of this specification, illustrate embodiments of the invention and together with the description serve to explain the principles of embodiments of the invention.

FIGS. 1A-1D are perspective views of manufacturing a microfluidic chip mold according to the related art.

FIG. 2 illustrates the steps of manufacturing a microfluidic chip according to the related art.

FIG. 3 is a flow chart illustrating the steps of manufacturing of a microfluidic chip for a microfluidic system according to an embodiment of the present invention.

FIG. 4 is a perspective view of the microfluidic chip according to an embodiment of the present invention.

FIG. 5 is a side view of the microfluidic chip shown in FIG. 4.

FIG. 6 is a side view of the microfluidic chip according to another embodiment of the present invention.

FIG. 7 is another side view of the microfluidic chip shown in FIG. 6.

FIG. 8 illustrates an application of the microfluidic chip shown in FIG. 7.

FIG. 9 is a side view of the microfluidic chip according to another embodiment of the present invention.

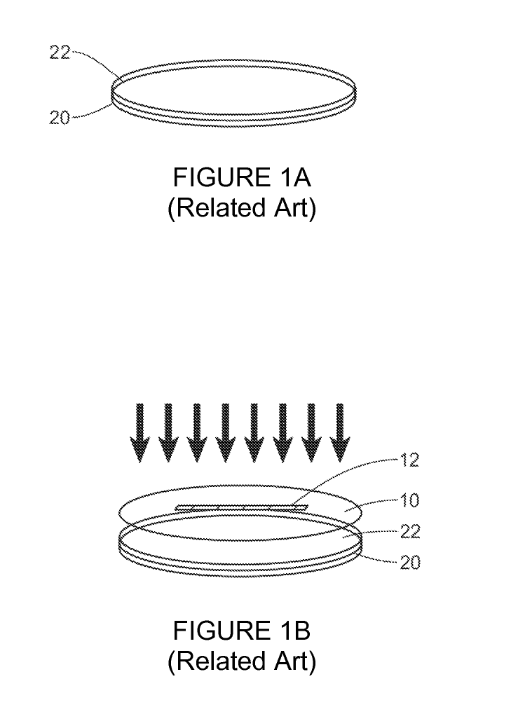

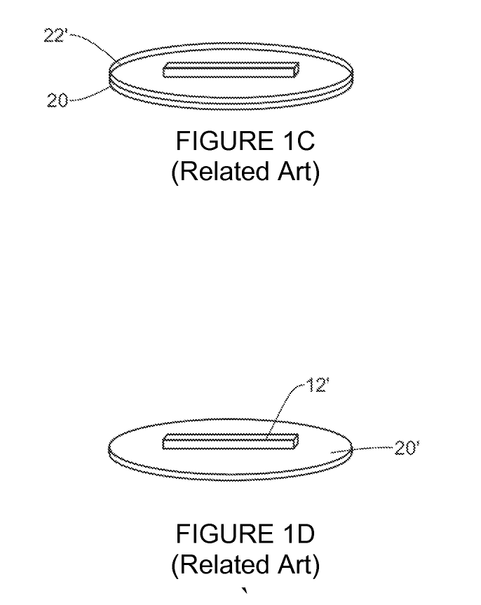

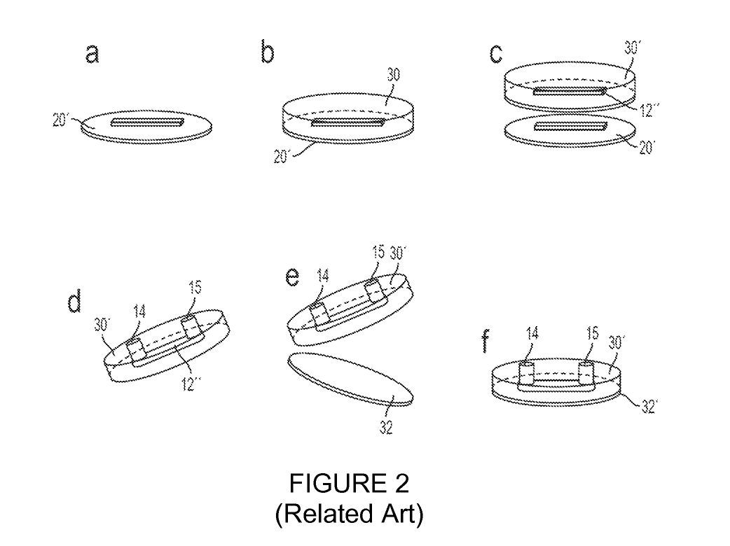

### DETAILED DESCRIPTION OF THE PREFERRED EMBODIMENTS

Reference will now be made in detail to the preferred embodiments of the invention, examples of which are illustrated in the accompanying drawings.

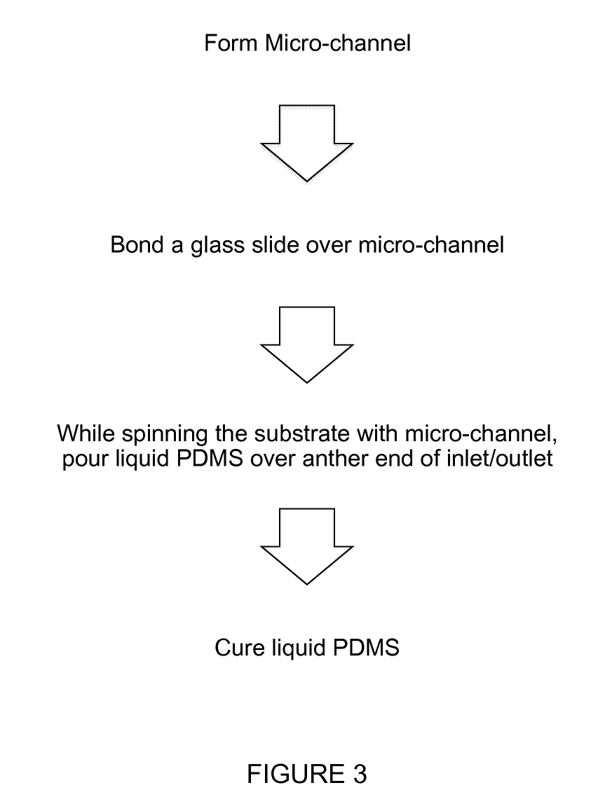

FIG. 3 is a flow chart illustrating the steps of manufacturing of a microfluidic chip for a microfluidic system according to an embodiment of the present invention. As shown in FIG. 3, at least one micro-channel is formed in a chip. The chip may be PDMS, silicon or glass chip. A master mold may be used to form micro-channels in PDMS chips, and a series of photolithography with photomasks may be used to form micro-channels in silicon or glass chip. The chip with micro-channel has an open surface, which is a surface of the chip that has at least the inlet and outlet openings.

While the chip is spun, liquid PDMS or a rubber material is poured over the open surface of the chip. Once a thin uniform layer of liquid PDMS or the rubber material is formed, then, the thin layer of liquid PDMS or the rubber material is hardened. For example, the chip may be baked or exposed to UV to cure the thin layer of liquid PDMS.

The hardened thin layer of PDMS or rubber forms a seal to the open surface. The microfluidic chip then can be transported without an open surface. Immediately prior to application, a needle or another piping can pierce through the thin hardened thin layer of PDMS or rubber to gain access to the micro-channel of the chip. Further, due to the elasticity and small thickness of the PDMS layer, the PDMS layer squeezes around the needle or piping to create a seal around the needle or piping.

Therefore, the hardened thin layer of PDMS or rubber provides seals to the microfluidic chip during transportation or prior to application, as well as during application. During application and after being pierced, the hardened thin layer of PDMS or rubber seals around the needles and continue to prevent particles or contaminants entering the micro-channel.

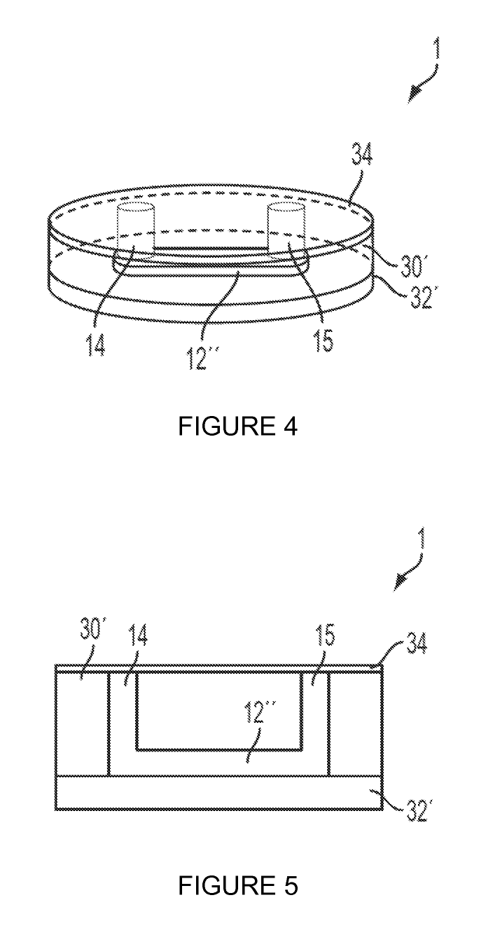

FIG. 4 is a perspective view of the microfluidic chip according to an embodiment of the present invention, and FIG. 5 is a side view of the microfluidic chip shown in FIG. 4. The microfluidic chip 1 includes a substrate 30, a micro-channel 12″ in the substrate 30′, and an inlet 14 and an outlet 15 in the substrate 30′. The micro-channel 12″ is formed in a first surface of the substrate 30′ and sealed with a glass side 32′. The inlet 14 and the outlet 15 are formed on an opposing surface of the substrate 30′ and into the substrate 30′. The inlet 14 and the outlet 15 are connected to the micro-channel 12″. The inlet 14 may be at one end of the micro-channel 12″, and the outlet 15 may be at another end of the micro-channel 12″.

The microfluidic chip I further includes a seal layer 34 over the openings of the inlet 14 and the outlet 15. The seal layer 34 may be a hardened PDMS layer or a rubber layer. The seal layer 34 may be formed by first pouring liquid PDMS while spinning the substrate 30′ to create a thin layer of liquid PDMS and hardening the thin layer of liquid PDMS. Alternatively, a rubber material may be used instead of liquid PDMS.

As shown in FIG. 5, the thickness of the seal layer 34 is smaller than the thickness of the substrate 30′ and the thickness of the glass slide 32′. The thickness of the seal layer 34 is small enough to allow a needle or a piping to subsequently pierce through the seal layer 34. The seal layer 34 provides sealing the interconnect between larger macro piping and the micro-channel 12″. With the seal layer 34, fluid can be pumped into the microfluidic chip 1 for processing without concern for the fluid leaking despite high pressure required to pump or drive the fluid into the micro-channel 12″.

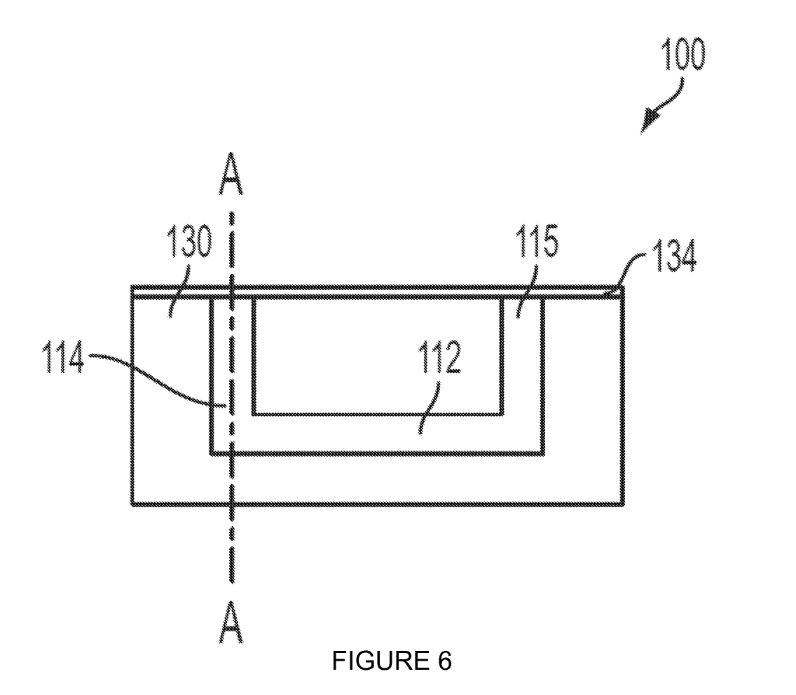

FIG. 6 is a side view of the microfluidic chip according to another embodiment of the present invention. In FIG. 6, a microfluidic chip 100 includes a substrate 130, a micro-channel 112 in the substrate 130, and an inlet 114 and an outlet 115 in the substrate 130. The micro-channel 112 is formed in the middle of the substrate 130. The inlet 114 and the outlet 115 are formed on an opposing surface of the substrate 130 and into the substrate 130. The inlet 114 and the outlet 115 are connected to the micro-channel 112. The inlet 114 may be at one end of the micro-channel 112, and the outlet 115 may be at another end of the micro-channel 112.

The microfluidic chip 100 further includes a seal layer 134 over the openings of the inlet 114 and the outlet 115. The seal layer 134 may be a hardened PDMS layer or a rubber layer. The seal layer 134 may be formed by first pouring liquid PDMS while spinning the substrate 130 to create a thin layer of liquid PDMS and hardening the thin layer of liquid PDMS. Alternatively, a rubber material may be used instead of liquid PDMS.

The thickness of the seal layer 134 is smaller than the thickness of the substrate 130. In particular, the thickness of the seal layer 134 is small enough to allow a needle or a piping to subsequently pierce through the seal layer 134. The seal layer 134 provides sealing the interconnect between larger macro piping and the micro-channel 112. With the seal layer 134, fluid can be pumped into the microfluidic chip 100 for processing without concern for the fluid leaking despite high pressure required to pump or drive the fluid into the micro-channel 112.

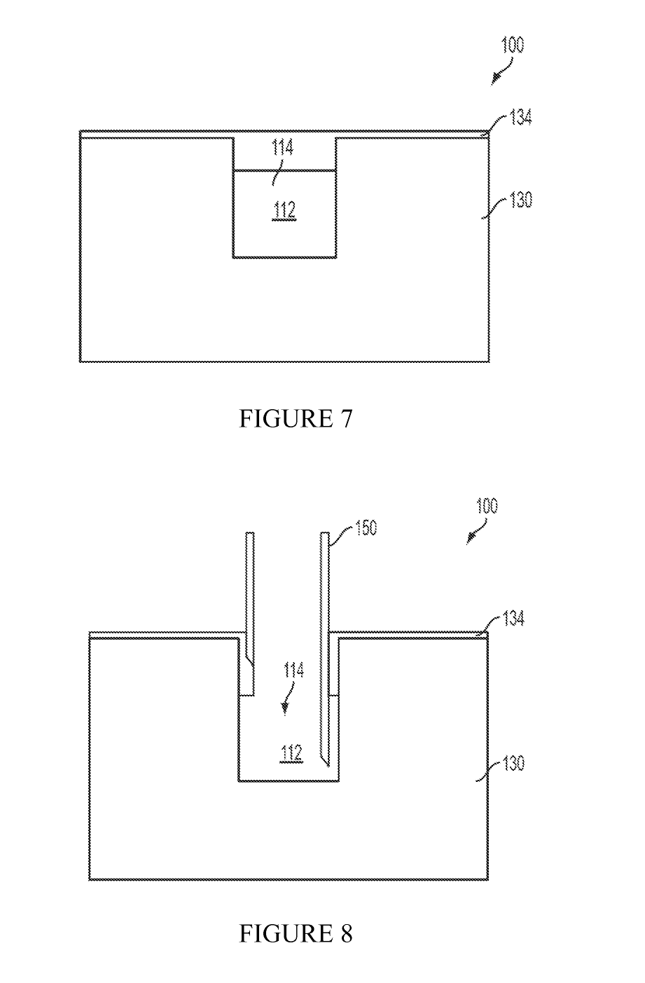

FIG. 7 is another side view of the microfluidic chip shown in FIG. 6, and FIG. 8 illustrates an application of the microfluidic chip shown in FIG. 7. As shown in FIG. 7, the seal layer 134 seals the inlet 114 and the micro-channel 112 from exterior environment. The seal 134 prevents particles or contaminants entering the micro-channel 112.

As shown in FIG. 8, a needle or a piping 150 can subsequently pierce through the seal layer 134 to set up pumping of fluid sample into the micro-channel 112. Despite being pierced through, the seal layer 134 squeezes around the needle or piping 150, thereby creating a seal around the needle or piping 150. As a result, fluid can be pumped into the microfluidic chip 100 for processing without concern for the fluid leaking despite high pressure required to pump or drive the fluid into the micro-channel 112.

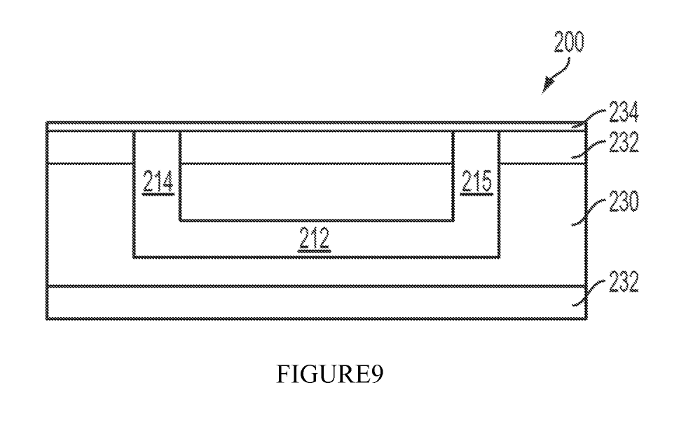

FIG. 9 is a side view of the microfluidic chip according to another embodiment of the present invention. In FIG. 9, a microfluidic chip 200 includes a substrate 230, a micro-channel 212 in the substrate 230, and an inlet 214 and an outlet 215 in the substrate 230. The substrate 230 is on a bottom slide 232. The bottom slide 232 can provide enforcement structure for the microfluidic chip 200.

The micro-channel 212 is formed in the middle of the substrate 230. The inlet 214 and the outlet 215 are formed on an opposing surface of the substrate 230 and into the substrate 230. The inlet 214 and the outlet 215 are connected to the micro-channel 212. The inlet 214 may be at one end of the micro-channel 212, and the outlet 215 may be at another end of the micro-channel 212. A top slide 234 is over the substrate 230, and the inlet 214 and the outlet 215 are through the top slide 234. The top slide 234 can provide enforcement structure for the microfluidic chip 200.

The microfluidic chip 200 further includes a seal layer 234 over the openings of the inlet 214 and the outlet 215. The seal layer 234 may be a. hardened PDMS layer or a rubber layer. The seal layer 234 may be formed by first pouring liquid PDMS while spinning the substrate 230 to create a thin layer of liquid PDMS and hardening the thin layer of liquid PDMS. Alternatively, a rubber material may be used instead of liquid PDMS.

The thickness of the seal layer 234 is smaller than the thickness of the substrate 230. In particular, the thickness of the seal layer 234 is small enough to allow a needle or a piping to subsequently pierce through the seal layer 234. The seal layer 234 provides sealing the interconnect between larger macro piping and the micro-channel 212. With the seal layer 234, fluid can be pumped into the microfluidic chip 200 for processing without concern for the fluid leaking despite high pressure required to pump or drive the fluid into the micro-channel 212.

It will be apparent to those skilled in the art that various modifications and variations can be made in the microfluidic chip of embodiments of the invention without departing from the spirit or scope of the invention. Thus, it is intended that embodiments of the invention cover the modifications and variations of this invention provided they come within the scope of the appended claims and their equivalents.

What is claimed:

1. A method for manufacturing a microfluidic chip device, comprising:
spinning a substrate having a first thickness and at least one microfluidic pathway in the substrate;
depositing a layer of liquid PDMS onto the substrate; and
hardening the PDMS layer, wherein the PDMS layer has a second thickness, and the second thickness is smaller than the first thickness.

2. The method according to claim 1, further comprising:
forming an inlet and an outlet on a surface of the substrate and into the substrate, wherein the inlet and the outlet connect to the microfluidic pathway,
wherein the step of forming the inlet and the outlet is performed prior to depositing the layer of liquid PDMS, and the liquid PDMS is deposited on the surface of the substrate.

3. A microfluidic chip device, comprising:
a substrate having a first thickness;
at least one microfluidic pathway in the substrate; and
a PDMS seal layer of a second thickness on the substrate and above the microfluidic pathway, wherein the PDMS seal layer provides a seal above the microfluidic pathway and the second thickness is smaller than the first thickness.

4. The device according to claim 3, further comprising:
an inlet and an outlet on a surface of the substrate and into the substrate, wherein the inlet and the outlet connect to the microfluidic pathway, and the PDMS seal layer is on the surface of the substrate over the inlet and the outlet.

5. A microfluidic chip device, comprising:
a substrate having a first thickness;
at least one microfluidic pathway in the substrate; and
a rubber seal layer of a second thickness on the substrate and above the microfluidic pathway, wherein the rubber seal layer provides a seal above the microfluidic pathway and the second thickness is smaller than the first thickness.

6. The device according to claim 5, further comprising:
an inlet and an outlet on a surface of the substrate and into the substrate, wherein the inlet and the outlet connect to the microfluidic pathway, and the rubber seal layer is on the surface of the substrate over the inlet and the outlet.
